(19) United States
(12) Patent Application Publication
(10) Pub. No.: US 2013/0333572 A1
(43) Pub. Date: Dec. 19, 2013

(54) SEPARATOR APPARATUS FOR PURIFYING A GAS STREAM

(71) Applicants: Chandrashekhar Sonwane, Canoga Park, CA (US); Scott D. Halloran, Canoga Park, CA (US)

(72) Inventors: Chandrashekhar Sonwane, Canoga Park, CA (US); Scott D. Halloran, Canoga Park, CA (US)

(21) Appl. No.: 13/526,035

(22) Filed: Jun. 18, 2012

(51) Int. Cl. B01D 53/14; B01D 53/02

(52) U.S. Cl. 96/134; 261/76

(57) ABSTRACT

A separator apparatus includes an expansion nozzle having spray elements and a tunnel coupled with the expansion nozzle. The tunnel includes a wall having a plurality of perforations.

### BACKGROUND

This disclosure relates to the purification of emission gas streams.

Chemical plants, such as power plants, emit exhaust gas streams that include pollutants, such as SOₓ, NOₓ and COₓ. One approach to at least reduce carbon dioxide emissions is to outfit an existing power plant with a post-combustion device that solidifies and captures the carbon dioxide. For example, such a device includes a compressor to compress the exhaust gas to a moderate level and send the compressed gas to a separator. The separator includes a supersonic nozzle that expands the compressed gas to lower the temperature and freeze the carbon dioxide into solid particles. Swirl vanes in the separator drive the solidified carbon dioxide particles to the periphery of the device for collection and removal. The purified gas stream then continues through an outlet diffuser to a chimney. There are also devices for treating waste streams with limestone for the removal of SOₓ. Although effective, such devices require substantial capital investment and have no ability to remove different types of pollutants. In addition, these types of devices consume heat and electric power, which reduces overall power output and efficiency.

### SUMMARY

A separator apparatus according to an exemplary aspect of the present disclosure includes an expansion nozzle that has spray elements and a tunnel coupled with the expansion nozzle. The tunnel includes a wall that has a plurality of perforations.

In a further non-limiting embodiment of the above example, the tunnel includes a turn.

In a further non-limiting embodiment of any of the foregoing examples, the tunnel has a serpentine geometry.

In a further non-limiting embodiment of any of the foregoing examples, the expansion nozzle has a fixed geometry.

In a further non-limiting embodiment of any of the foregoing examples, the expansion nozzle has a variable geometry.

In a further non-limiting embodiment of any of the foregoing examples, the expansion nozzle includes at least one of a spring device, a magnetic device and a pneumatic device, configured to change the variable geometry.

In a further non-limiting embodiment of any of the foregoing examples, the tunnel includes a collector portion having the plurality of perforations, the collector portion including an adsorbent material.

In a further non-limiting embodiment of any of the foregoing examples, the tunnel includes a passage extending between an inlet and an outlet, and a water-based feed near the outlet.

In a further non-limiting embodiment of any of the foregoing examples, the tunnel includes a passage extending between an inlet and an outlet, and the expansion nozzle is located at the inlet and another expansion nozzle is located at the outlet, the expansion nozzles each having a variable geometry.

A further non-limiting embodiment of any of the foregoing examples includes a controller in communication with the expansion nozzles, the controller being operable to change the variable geometry of the respective expansion nozzles in response to a condition in the passage.

A further non-limiting embodiment of any of the foregoing examples includes a baffle structure within the tunnel.

In a further non-limiting embodiment of any of the foregoing examples, the baffle structure includes a honeycomb.

A further non-limiting embodiment of any of the foregoing examples includes a screen within the tunnel.

A purification process according to an exemplary aspect of the present disclosure includes expanding a flue gas through a nozzle, wherein the flue gas has a target constituent to be removed therefrom, spraying a reactant into the nozzle and phase changing the target constituent by reacting the target constituent with the reactant.

A purification process according to an exemplary aspect of the present disclosure includes providing a gas stream, including a target constituent to be removed therefrom, into a separator apparatus including a tunnel having a passage extending between an inlet and an outlet, selectively varying an area of a first variable area nozzle of the inlet and an area of a second variable area nozzle of the outlet to establish a desired condition within the passage, the desired condition corresponding to a critical condition at which the target constituent forms a condensed material, and collecting the condensed material in a collector in communication with the passage.

In a further non-limiting embodiment of any of the foregoing examples, the critical condition is a phase change temperature of the target constituent.

In a further non-limiting embodiment of any of the foregoing examples, the critical condition is a reaction temperature of the target constituent.

A further non-limiting embodiment of any of the foregoing examples includes selectively varying the area of the first variable area nozzle and the area of the second variable area nozzle to change at least one of temperature and pressure within the passage and cause removal the condensed material from the collector.

A further non-limiting embodiment of any of the foregoing examples includes selectively varying the area of a first variable area nozzle and the area of a second variable area nozzle to adjust flow through the passage over a polysonic flow range.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 shows an example chemical plant.

FIG. 2 shows an example separator apparatus.

FIG. 3 shows a modified example of a separator apparatus.

FIG. 4 shows another example separator apparatus.

FIG. 5 shows another example separator apparatus.

FIG. 6 shows an example of spray elements in a separator apparatus.

FIG. 7 shows another example separator apparatus.

### DETAILED DESCRIPTION OF THE PREFERRED EMBODIMENT

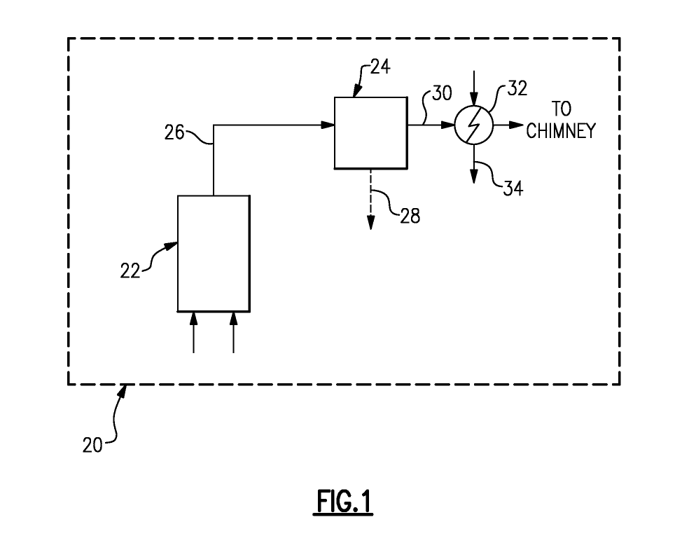

FIG. 1 illustrates selected portions of an example chemical plant 20. As can be appreciated, the chemical plant 20 is shown highly schematically for the purposes of this description. The chemical plant 20 includes a reactor 22 and a separator apparatus 24 in receiving communication with an exhaust 26 from the reactor 22.

The reactor 22 can be a gasifier reactor for the production of a syngas, a coal boiler or other type of combustor, for example. As will be appreciated, the exhaust 26 emitted from the reactor 22 can include a variety of different constituents, depending upon the type of reactor 22. The constituents can include gases and fine particulates, such as SOₓ, NOₓ, COₓ, H₂S, benzene, mercury and/or other constituents, for example. Additionally, the exhaust 26 is typically emitted at a relatively high temperature, again depending upon the type of reactor 22. One or more of the constituents are to be removed prior to emission of the exhaust 26 to a chimney or stack. In this regard, the separator 24 removes at least a portion of the constituents prior to emission of the exhaust 26 to the chimney.

As shown, the separator 24 separates the exhaust 26 into a separated, waste stream 28 and a purified gas stream 30 that continues on to the chimney. In this example, the chemical plant 20 optionally includes a heat exchanger 32 in receiving communication with the separator 24. The heat exchanger 32 permits recovery of thermal energy from the purified gas stream 30 into another stream 34, which may be used in the process related to the reactor 22, for power generation, or other purpose(s).

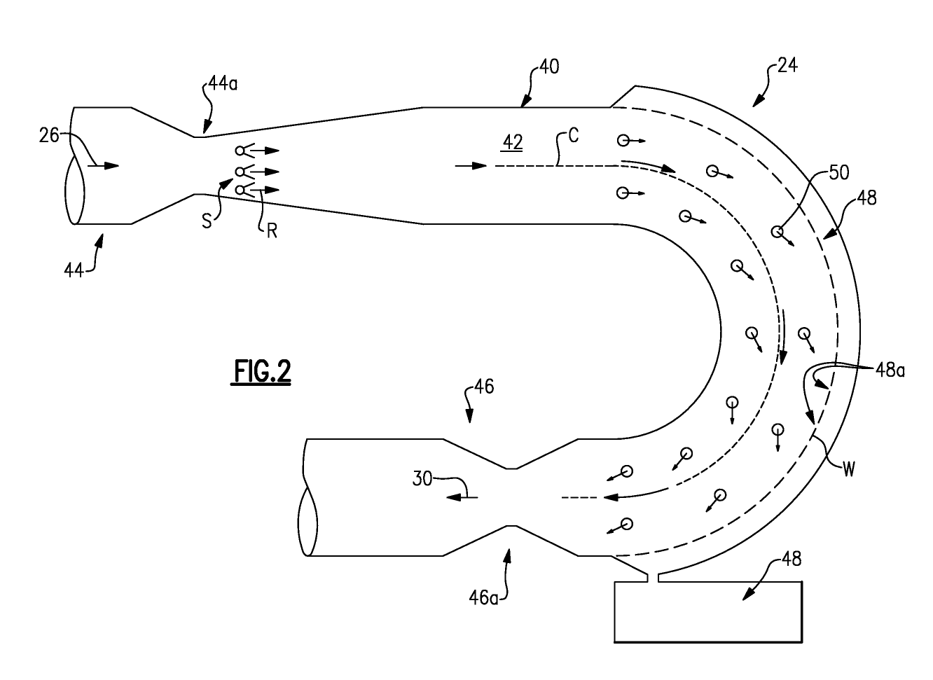

FIG. 2 illustrates an example of the separator 24 of the chemical plant 20. In this example, the separator 24 includes a tunnel 40 that defines a passage 42 that extends between an inlet 44 and an outlet 46. The tunnel 40 can be cylindrical, rectangular or have another geometric cross-sectional shape, for example. The inlet 44 includes a first expansion nozzle 44a and the outlet 46 includes a second expansion nozzle 46a. The expansion nozzles 44a/46a are coupled the tunnel 40 and have a fixed geometry. In this example, the expansion nozzles 44a/46a each have a convergent-divergent geometry. The first expansion nozzle 44a includes spray elements S for spraying a reactant R into the expansion nozzle 44a and tunnel 40.

A collector 48 is in communication with the passage 42. The collector 48 is configured to entrap condensed material 50 from the passage 42. For example, the collector 48 includes a wall W that bounds the passage 42 and has a plurality of perforations 48a that mechanically entrap the condensed material 50. In a further example, the wall W includes an adsorbent material to directly remove the target constituent in the gas phase, for example. As can be appreciated, the selected adsorbent will depend upon the type of target constituent(s) being removed. In examples, the adsorbent is or includes calcium carbonate or ammonium-based adsorbent.

The exhaust 26 from the reactor 22 is provided into the separator 24 through the inlet 44. The exhaust expands through the expansion nozzle 44a. The reactant R is sprayed into the expansion nozzle 44a through the spray elements S. The reactant R reacts with the target constituent to cause a phase change of the target constituent into the condensed material 50. The condensed material 50 is then collected in the collector 48 and is thus removed from the exhaust 26 to produce the purified gas stream 30.

In this example, the passage 42 extends along a central, non-linear axis C between the inlet 44 and the outlet 46 and turns about 180°. Thus, the exhaust 26 travelling through the passage 42 is forced to turn with the shape of the passage 42. While the gas within the exhaust 26 turns through the passage 42, the heavier, condensed material 50 is centrifugally driven toward the periphery to the wall W and perforations 48a of the collector 48. After a period of collection, the condensed material 50 can be removed from the collector 48.

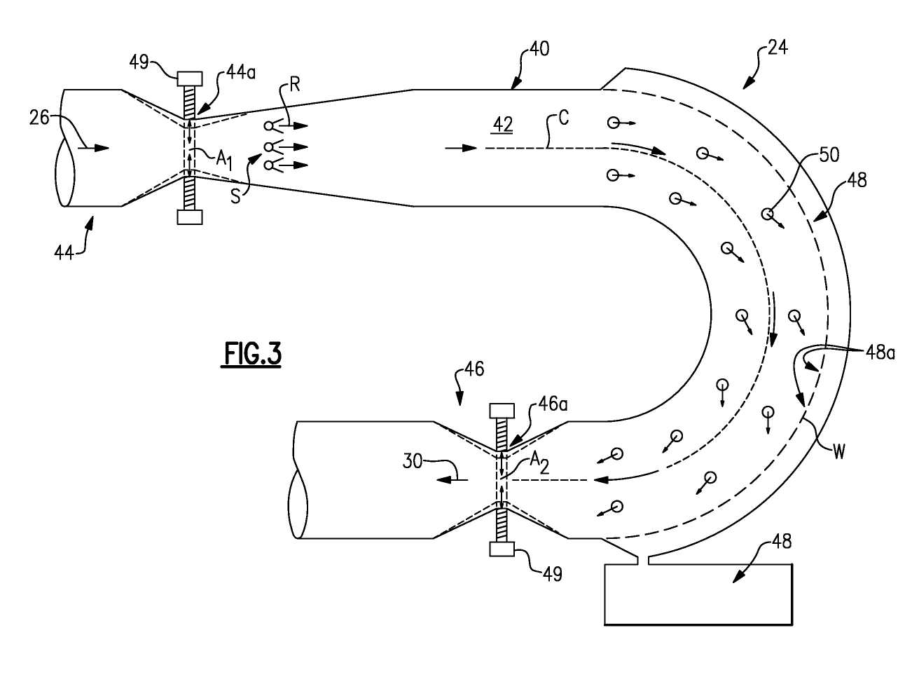

FIG. 3 illustrates a modified example of the separator 24. In this example, the expansion nozzle 44a has a variable geometry defining a first cross-sectional area A₁ and the second expansion nozzle 46a has a variable geometry defining a second cross-sectional area A₂. The expansion nozzles are thus variable area nozzles 44a/46a. Each of the variable area nozzles 44a/46a includes a respective actuator 49 for changing the respective areas A₁ and A₂. For example, the actuators 49 are spring devices, magnetic devices or pneumatic devices. The actuation of the variable area nozzles 44a/46a are shown in phantom by dashed lines in the drawing. In this regard, the inlet 44 and the outlet 46 of the tunnel 40 are flexible to permit actuation. At least the inlet 44 and the outlet 46 are formed of a pliable material, such as but not limited to polyurethane, which permits the inlet 44 and the outlet 46 to expand and contract in response to actuation.

The exhaust 26 from the reactor 22 is provided into the separator 24 through the inlet 44. The variable area nozzles 44a/46a selectively vary the respective areas A₁ and A₂ to control the flow of the exhaust 26 into the separator 24 and the flow of the purified gas stream 30 from the separator 24. Controlling the flow at the inlet 44 and at the outlet 46 controls expansion of the exhaust 26 within the passage 42 to thereby control the conditions within the passage 42 with regard to temperature and pressure. That is, the areas A₁ and A₂ are selectively varied to establish a desired flow, and thus a desired temperature and/or pressure within the passage 42. The separator 24 can be adjusted to change the flow through the passage 42 over a polysonic flow range, such as subsonic, transonic or supersonic flow, for example, depending on the desired conditions in the passage 42 for removing a target constituent.

For example, the desired condition corresponds to a critical condition at which one or more target constituents in the exhaust 26 form the condensed material 50 within the passage 42. The term “condensed material” as used in this description refers to liquid and/or solid materials. Further, the condensed material can be the product of a phase change, a product of a reaction, a product of a coalescence between a liquids and/or solids, or combinations thereof, irrespective of the whether the target constituent is a gas, liquid or solid to start with in the exhaust 26.

The areas A₁ and A₂ can be changed depending on the desired conditions within the passage 42 for removal of a target constituent. Thus, for a first type of target constituent, the variable area nozzles 44a/46a can be moved to predetermined areas A₁ and A₂ to establish a desired critical condition, such as temperature, within the passage 42 for removal of the first constituent. If a second, different type of target constituent is to be removed, the nozzles 44a/46a can be moved to different predetermined areas A₁ and A₂ to establish a desired critical condition within the passage 42 for removal of the second constituent. Thus, the separator 24 has the ability to remove a variety of different types of constituents by adjusting the areas A₁ and A₂ and does not require a fan, compressor or cooling water at the inlet, which otherwise increases cost and generates a large amount of waste water.

In further examples, the variable area nozzles 44a/46a can be moved to predetermined areas A₁ and A₂ to establish a flow within the passage 42 between Mach numbers of 1.5 and 0.05 to reduce the temperature of the exhaust 26 from 200-400° F. (93-205° C.) to 30-60° F. (1.1-16° C.) for the removal of condensable gases and liquids by phase change. In general, establishing a flow of greater than Mach 1 permits removal of condensable gases, such as COₓ and SOₓ, at very low temperatures.

After a period of collection, the condensed material 50 can be removed from the collector 48. For example, the condensed material 50 can be removed as a solid or the variable area nozzles 44a/46a can be moved to establish conditions for release of the condensed material 50 from the collector 48. In the latter technique, the variable area nozzles 44a/46a are moved to change pressure within the passage 42 such that the condensed material 50 vaporizes. The vaporized material is then removed using the exhaust 26 as sweep gas, which is then collected in a separate stream.

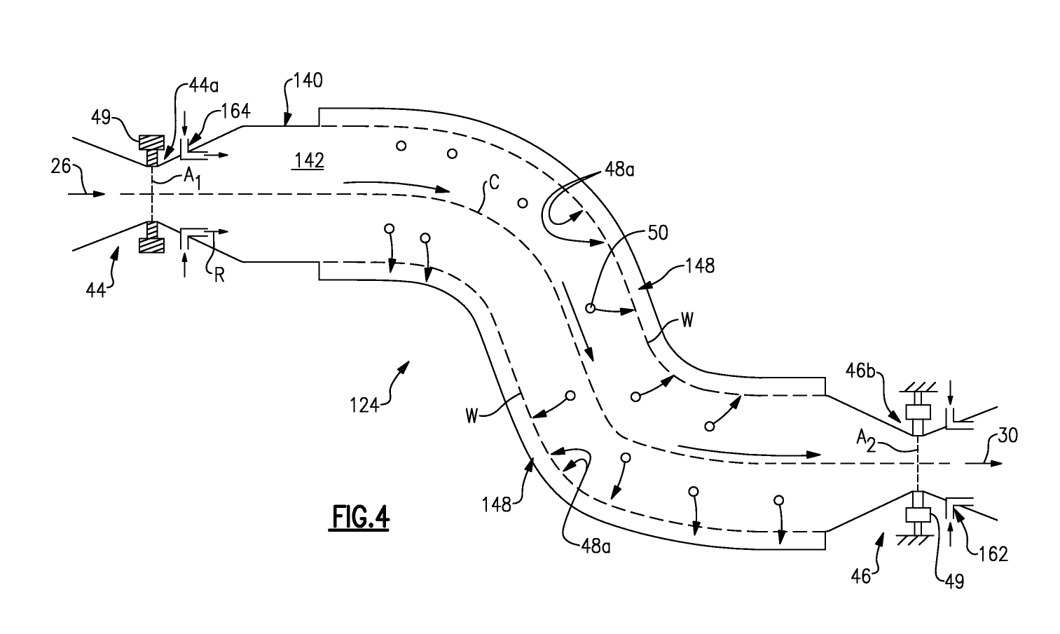

FIG. 4 illustrates another separator apparatus 124. In this disclosure, like reference numerals designate like elements where appropriate and reference numerals with the addition of one-hundred or multiples thereof designate modified elements that are understood to incorporate the same features and benefits of the corresponding elements. In this example, the passage 142 extends along a central axis C. The central axis C includes two inflections, or turns, and thus the passage 142 is serpentine. In further examples, the central axis C can include additional inflections for further separation of the condensed material 50. At each of the inflections, the relatively heavy, condensed material 50 is centrifugally driven toward the periphery to the wall W and perforations 48a of the collector 148. Thus, the collector 148 is located towards the outside at each of the inflections.

Additionally, in this example, the separator 124 includes a water-based feed 162 within or near the outlet 46 and spray elements 164 within or near the inlet 44. The spray elements 164 provides a reactant R into the exhaust 26 for reaction with a target constituent or constituents under the critical conditions generated using the variable area nozzles 44a/46a. The selected reactant R will depend upon the target constituent(s) to be removed. In one example, the reactant R is or includes a limestone/water slurry (Ca(OH)₂), also known as milk of lime, for targeted reaction with SOₓ to form calcium sulfate as the condensed material 50. The calcium sulfate may later be converted to gypsum for industrial as wall board or other use, for example.

The water-based feed 162 provides a water-based stream, such as steam and, optionally, recycled gas from the purified gas stream 30, into the outlet 46 to increase the flow velocity of the purified gas stream 30. That is, as the exhaust 26 passes through the passage 142, there is a pressure loss between the inlet 44 and the outlet 46. The injection of the steam increases the flow velocity to restore some of the pressure that is lost. Alternatively, a pump can be implemented in place of or in addition to the water-based feed 162.

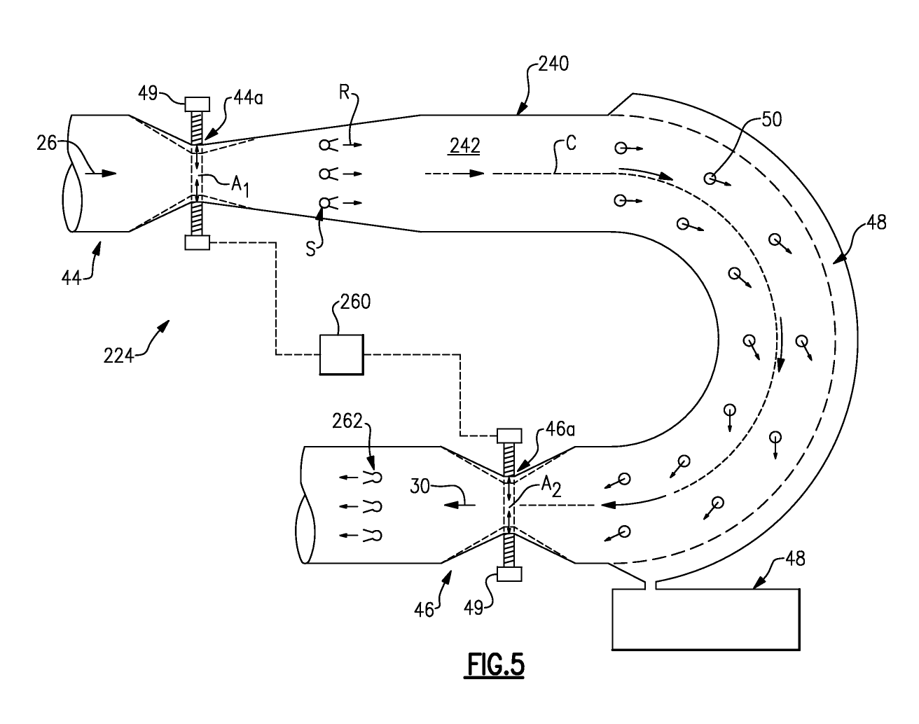

FIG. 5 illustrates another example separator apparatus 224 that is somewhat similar to the separator 24 of FIG. 3. In this example, the variable area nozzles 44a/46a are in communication with a controller 260 to control the operation thereof. As can be appreciated, any of the separators disclosed herein can include a similar controller.

The controller 260 signals the actuators 49 of the variable area nozzles 44a/46a to selectively change the areas A₁ and A₂, depending on the desired critical condition within the passage 242 for the target constituent to be removed. Thus, for a first type of target constituent, the controller 260 commands the nozzles 44a/46a to move to predetermined areas A₁ and A₂ to establish a desired critical condition within the passage 242 for removal of the first constituent. For a second, different type of target constituent, the controller 260 can command the nozzles 44a/46a to move to different predetermined areas A₁ and A₂ to establish a desired critical condition within the passage 242 for removal of the second constituent.

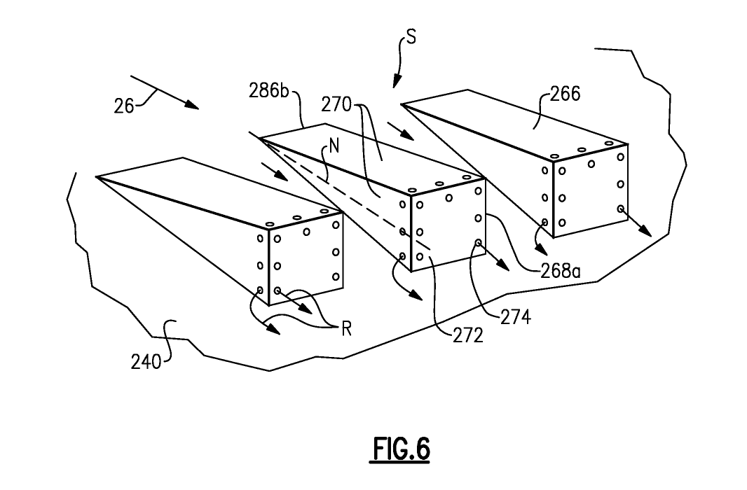

FIG. 6 shows an example of the spray elements S herein. The spray elements S include nozzles 266 mounted on the interior of the tunnel 240. Each reactant nozzle 266 extends along a longitudinal axis N and tapers between an enlarged end 268a and a narrow end 268b located upstream from the enlarged end 268a. Each nozzle 266 includes lateral surfaces 270, relative to the axis N, and an end surface 272 joining the lateral surfaces 270. The enlarged end 268a includes discharge openings 274 for emitting the reactant R. In this example, each of the lateral surfaces 270 and the end surface 272 includes discharge openings 274, to ensure proper mixing of the reactant R into the exhaust 26. Further, the wedge or ramp-shape of the nozzles 266 reduces flow resistance of the exhaust 26.

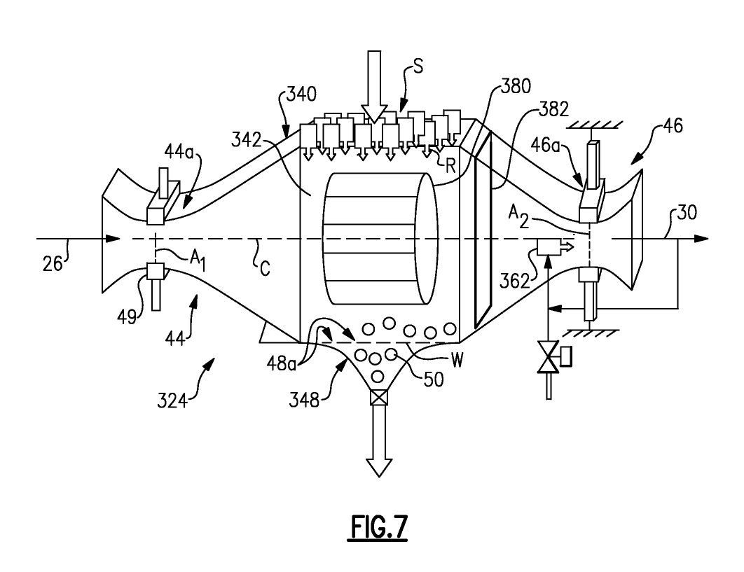

FIG. 7 illustrates another example separator apparatus 324. In this example, the passage 342 is linear along central axis C between the inlet 44 and the outlet 46 and the separator 324 includes a baffle structure 380 and a screen 382 within the passage 342. The baffle structure 380 facilitates mixing of the exhaust 26 and the reactant R provided from the spray elements S, and the screen 382 facilitates the removal of particles and mist from the exhaust 26. In this example, the baffle structure 380 is a honeycomb.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A separator apparatus comprising:
an expansion nozzle including spray elements; and
a tunnel coupled with the expansion nozzle, the tunnel including a wall having a plurality of perforations.

2. The separator apparatus as recited in claim 1, wherein the tunnel includes a turn.

3. The separator apparatus as recited in claim 1, wherein the tunnel has a serpentine geometry.

4. The separator apparatus as recited in claim 1, wherein the expansion nozzle has a fixed geometry.

5. The separator apparatus as recited in claim 1, wherein the expansion nozzle has a variable geometry.

6. The separator apparatus as recited in claim 5, wherein the expansion nozzle includes at least one of a spring device, a magnetic device and a pneumatic device, configured to change the variable geometry.

7. The separator apparatus as recited in claim 1, wherein the tunnel includes a collector portion having the plurality of perforations, the collector portion including an adsorbent material.

8. The separator apparatus as recited in claim 1, wherein the tunnel includes a passage extending between an inlet and an outlet, and a water-based feed near the outlet.

9. The separator apparatus as recited in claim 1, wherein the tunnel includes a passage extending between an inlet and an outlet, and the expansion nozzle is located at the inlet and another expansion nozzle is located at the outlet, the expansion nozzles each having a variable geometry.

10. The separator apparatus as recited in claim 9, further comprising a controller in communication with the expansion nozzles, the controller being operable to change the variable geometry of the respective expansion nozzles in response to a condition in the passage.

11. The separator apparatus as recited in claim 1, further comprising a baffle structure within the tunnel.

12. The separator apparatus as recited in claim 11, wherein the baffle structure includes a honeycomb.

13. The separator apparatus as recited in claim 1, further comprising a screen within the tunnel.

14. A purification process comprising:
expanding a flue gas through a nozzle, wherein the flue gas has a target constituent to be removed therefrom;
spraying a reactant into the nozzle; and
phase changing the target constituent by reacting the target constituent with the reactant.

15. A purification process comprising:
providing a gas stream, including a target constituent to be removed therefrom, into a separator apparatus including a tunnel having a passage extending between an inlet and an outlet;
selectively varying an area of a first variable area nozzle of the inlet and an area of a second variable area nozzle of the outlet to establish a desired condition within the passage, the desired condition corresponding to a critical condition at which the target constituent forms a condensed material; and
collecting the condensed material in a collector in communication with the passage.

16. The method as recited in claim 15, wherein the critical condition is a phase change temperature of the target constituent.

17. The method as recited in claim 15, wherein the critical condition is a reaction temperature of the target constituent.

18. The method as recited in claim 15, further comprising selectively varying the area of the first variable area nozzle and the area of the second variable area nozzle to change at least one of temperature and pressure within the passage and cause removal the condensed material from the collector.

19. The method as recited in claim 15, further comprising selectively varying the area of a first variable area nozzle and the area of a second variable area nozzle to adjust flow through the passage over a polysonic flow range.
